(19) United States
(12) Patent Application Publication
(10) Pub. No.: US 2015/0161918 A1
(43) Pub. Date: Jun. 11, 2015

(54) Time-Dependent Label

(71) Applicants: Cormac Patrick Byrne, Belfast (GB); Brian Joseph Meenan, Ballinderry Upper (GB); Cormac Flynn, Shannon (IE)

(72) Inventors: Cormac Patrick Byrne, Belfast (GB); Brian Joseph Meenan, Ballinderry Upper (GB); Cormac Flynn, Shannon (IE)

(73) Assignee: INNOVATION ULSTER LIMITED, Coleraine (GB)

(21) Appl. No.: 14/238,973

(22) PCT Filed: Aug. 16, 2012
(86) PCT No.: PCT/GB2012/052003

§ 371 Date: May 30, 2014

(30) Foreign Application Priority Data
Aug. 16, 2011 (GB) 1114086.0

(51) Int. Cl. G09F 3/00; B31D 1/02

(52) U.S. Cl. CPC G09F 3/0291; G09F 3/0297; B31D 1/027; G09F 2003/0202

(57) ABSTRACT

A label that changes appearance with time is disclosed. The label comprises a first layer that has different permeabilities to a gas in different lateral areas of the label and which comprises a substance that changes colour when in contact with the gas. The substance is arranged within the label such that the gas permeates across the thickness of the layer at different rates in different lateral areas so as to cause the substance to change colour at different rates in said different areas. Another label that changes appearance with time is disclosed that allows ink to permeate to its surface at different rates in different lateral areas.

The present invention relates to a label which is configured to produce an image that varies over time. In a preferred embodiment, the image changes when the label contacts one or more types of gas or vapour.

### BACKGROUND TO THE PRESENT INVENTION

Labels are frequently associated with products and used to indicate certain aspects related to the product such as, for example, the use-by date or price of the product. It is necessary to replace such labels over time depending on various factors, such as the storage conditions of the product or the proximity of the use-by date.

It is therefore desired to provide a convenient and reliable label that is able to change over time.

### SUMMARY OF THE INVENTION

From a first aspect, the present invention provides a product label comprising: a first layer that is permeable to at least one type of gas or vapour, wherein the permeable layer has different permeabilities to said gas or vapour in different lateral areas of said label; and a substance that changes colour, light reflectivity or light transmissivity when in contact with said gas or vapour; wherein the substance is arranged within said label such that said gas or vapour may permeate across the thickness of the layer at different rates in said different lateral areas so as to cause the substance to change colour, light reflectivity or light transmissivity at different rates in said different areas.

The present invention provides a label that produces an image that changes over time when the label is in contact with a particular gas or vapour. The label may therefore be used to indicate the length of time that the label has been in contact with such a gas or vapour. This label can be used to indicate the age or quality of a product, or the duration that a product has been stored under certain conditions.

Preferably, the substance that changes colour, light reflectivity or light transmissivity remains on one side of the layer and the gas or vapour permeates across the layer.

The gas or vapour may be one or more of the following: oxygen; carbon dioxide; water; an aldehyde; a ketone; or a product of decomposition of food. However, the invention may also be used with other types of gases or vapours.

The permeable layer is permeable to the gas or vapour without applying a pressure difference across said layer.

Preferably, the permeable layer is a membrane or film, e.g. a polymer membrane. The permeable layer may be transparent or translucent and the substance arranged so that the change in the substance can be seen through the layer.

The permeable layer is preferably arranged on an outermost surface of the label. Alternatively, the permeable layer may be provided between said substance and a removable barrier layer that prevents said gas or vapour contacting the permeable layer. In this arrangement, the barrier layer may be removed so as to permit the gas or vapour to contact and permeate the permeable layer.

The changeable substance may be provided between the permeable layer and a second layer. The second layer may be non-permeable to any gases or vapours so as to isolate the substance from gases or vapours other than those that permeate the first layer. Less preferably, the second layer is permeable to the same gas(es) or vapour(s) as said first permeable layer so that such gas(es) or vapour(s) can permeate the second layer and contact the substance.

The first layer may have at least two, three, four, five, six, seven, eight, nine or ten different lateral areas of different permeability to said gas or vapour. The areas of different permeability may be different discrete areas having well defined perimeters. Alternatively, the permeability to said gas or vapour across the thickness of the first layer may vary continually and gradually in a lateral direction.

Preferably, the first layer is porous and has different densities or sizes of pores in said different areas so that it has different permeabilities to said gas or vapour in said different lateral areas.

The substance that changes in the presence of the gas or vapour may be an ink. The substance may become more opaque to light, preferably visible light, in the presence of the gas or vapour. For example, the substance may change from being transparent to being non-transparent or opaque when in contact with said gas or vapour. Alternatively, the substance may become less opaque to light, preferably visible light, in the presence of the gas or vapour. For example, the substance may change from being translucent or opaque to being transparent when in contact with said gas or vapour. In a particular example, the substance is methylene blue mixed with glucose and the gas is oxygen.

The substance is arranged within the label to form an image which appears or changes across said lateral areas as time progresses, when the label is in contact with said gas or vapour. Preferably, the image formed by the substance at any given time across said lateral areas is indicative of the amount of time that the permeable layer has been in contact with said gas or vapour. Alternatively, or additionally, the image formed by the substance across said lateral areas may be indicative of the concentration of the gas or vapour that the permeable layer has been in contact with.

The change in the image may be a modification to an existing image and the existing image may have been formed by an ink other than said substance. Alternatively, the change in the image may be the formation of a new and discrete image. Different discrete images may be formed by the substance in the different areas.

The image(s) formed by the substance and/or pre-existing image may form at least a portion of a human or machine readable code, such as a barcode, QR code or alphanumeric string.

The change in the image may indicate a change in shelf life or the remaining shelf life of a product to which the label may be associated. Alternatively, or additionally, the change in the image may indicate a change in price of a product to which the label may be associated. Alternatively, or additionally, the change in the image may indicate that a product to which the label may be associated either should or should not be sold.

The present invention also provides a product having a label as described above attached to it.

The changeable substance may be arranged between the product and the first permeable layer such that the first layer is exposed to the atmosphere in which the product is located. Alternatively, the permeable layer may be arranged between the product and said substance such that the permeable layer is exposed to a gas or vapour that may be emitted by said product. In either case, the package may contain food and the gas or vapour may be a product of decomposition of said food.

The present invention also provides a package for a product comprising a label as described above.

The label may be attached to the outside surface of the package and the substance may be arranged between the package and the first layer such that the first layer may be exposed to the atmosphere in which the package is located. Alternatively, the permeable layer may be integral with and form at least part of a layer of the package, and the substance may be arranged towards the inside of said package relative to said permeable layer such that the permeable layer may be exposed to the atmosphere in which the package is located.

Alternatively, the label may be attached to the inside surface of the package and the substance may be arranged between the package and the permeable layer such that the label can monitor the internal atmosphere inside of the package. Alternatively, the permeable layer may be integral with and form at least part of a layer of the package, and the substance may be arranged towards the outside of said package relative to the permeable layer such that the label can monitor the internal atmosphere inside of the package. The gas or vapour may be a gas or vapour which is contained within the package or which may be formed within the package. Preferably, the package is sealed closed. Preferably, the package contains a product and the gas or vapour is one emitted by the product. For example, the package may contain food and the gas or vapour may be a product of decomposition of the food.

The present invention also provides a system comprising a label, product or package as described above and a machine for reading the label, wherein the substance in the label is arranged and configured to form an image that is readable by said machine and which changes as time progresses when the label is in contact with said gas or vapour, and wherein the machine is configured to detect the image in a plurality of its changed states and associate a parameter with the label that has a value that is dependent upon the state of the image at the time of detection.

The parameter value may be indicative of the amount of time that the label has been in contact with said gas or vapour. Alternatively, or additionally, the parameter value may be indicative of the concentration of said gas or vapour that the label has been in contact with. Alternatively, or additionally, the parameter value may indicate a change in shelf life or remaining shelf life of a product to which the label may be associated. Alternatively, or additionally, the parameter value may indicate a price of a product to which the label may be associated. Alternatively, or additionally, the parameter value may indicate that a product to which the label may be associated either should or should not be sold at the time of detection by said machine.

The preferred embodiment has a number of advantages. For example, the label may indicate a price drop of a product over time and so may encourage consumers to buy products close to their perish deadlines. This helps to ensure that viable items are not left to perish and so reduces waste and costs. The label may also help prevent goods from being sold which are beyond a certain age or which have degraded beyond a suitable quality.

The image may form at least part of a barcode, QR code or alphanumeric string that changes appearance when said permeable layer is exposed to said gas or vapour.

Preferably, the system comprises a display or other device and the machine controls the display or other device based on the value of one or more of said parameters. For example, the machine may control the display so as to indicate the price of the product that has been determined from the state of the time-dependent image at the time of scanning the image with the machine. Alternatively, or additionally, the machine may control the display so as to indicate that the product should or should not be sold or used, based on the state of the time-dependent image at the time of scanning the image with the machine.

The present invention also provides a method of indicating the state of a product by associating a label as described above with the product.

From a second aspect, the present invention provides a product label comprising: ink; and a first layer that is permeable to said ink, wherein the permeable layer has different permeabilities to said ink in different lateral areas of said label; and wherein the ink is arranged within the label on a first side of the permeable layer such that the ink may permeate across the thickness of the layer to a second side of the layer at different rates in said different lateral areas so that the ink on the second side of the layer forms a time-dependent visible image across said different areas.

The present invention therefore provides a label that produces an image, as seen from the second side of the permeable layer, that changes over time. The image formed by the ink on the second side of the permeable layer, at any given time, across said lateral areas may therefore be indicative of the age of the label and may be used, for example, to indicate the age of a product associated with the label.

The time-dependent image is preferably visible by a human, or less preferably only by a machine, from the second side of the permeable layer.

The layer is permeable to the ink without applying a pressure difference across said layer.

The layer may be a membrane or film, e.g. a polymer membrane or film.

The ink is preferably not visible from the second side of the permeable layer until the ink has eluted to the second side. The permeable layer may be a different colour to the ink.

The permeable layer may be a barrier to at least some frequencies of light and the ink may be a light-sensitive ink that changes colour in the presence of said frequencies of light. For example, the frequencies may be the frequencies of natural light, UV light, IR light or other frequencies. In this configuration, the label is configured to prevent light from reaching the ink until the ink has eluted to the second side of the permeable layer.

The permeable layer may be arranged on an outermost surface of the label.

The ink may be provided between the permeable layer and a second layer. In this arrangement, the second layer is preferably not permeable to the ink.

The first layer may have at least two, three, four, five, six, seven, eight, nine or ten different lateral areas of different permeability to the ink. The areas of different permeability may be different discrete areas having well defined perimeters. Alternatively, the permeability to the ink across the thickness of the first layer may vary continually and gradually in a lateral direction of the layer.

The first layer is preferably porous and has different densities or sizes of pores in said different areas so that it has different permeabilities to the ink in the different lateral areas.

In use, the ink may elute through the first layer and modify an existing image, as can be seen from said second side of the permeable layer. The existing image may be formed by an ink other than said ink which permeates the first layer.

The ink may elute through the first layer and form a new and discrete image, as seen from said second side of the permeable layer. Different discrete images may be formed by the ink in the different areas. Alternatively, the ink may form or modify a single continuous image.

The image(s) formed by the ink and/or pre-existing image, as seen from said second side, may form at least a portion of a human or machine readable code. For example, the image(s) formed by the ink and/or pre-existing image, as seen from said second side, may form at least a portion of an alphanumeric string. Alternatively, the machine-readable code may be a barcode or QR code.

The change in the image, as seen from the second side of the first layer, may indicate a change in shelf life of a product to which the label may be associated. Alternatively, or additionally, the change in the image as seen from the second side of the first layer may indicate a change in price of a product to which the label may be associated. Alternatively, or additionally, the change in the image as seen from the second side of the first layer may indicate that a product to which the label may be associated either should or should not be sold.

The present invention also provides a product having a label as described above (in relation to the second aspect of the present invention) attached to it.

The ink may be arranged between the product and the first permeable layer.

The product may be food.

The present invention also provides a package for a product comprising a label as described above in relation to the second aspect of the present invention.

The label may be attached to a surface of the package. Alternatively, the first permeable layer may be integral with and form at least part of a layer of the package, and the ink may be arranged towards the inside of said package relative to the permeable layer. The ink may then permeate through the permeable layer towards the outer surface of the package so that the time-dependent image can be seen from outside of the package. Preferably, the ink is printed on the first side of the first permeable layer.

The package preferably contains a product. The product may, for example be food.

The present invention also provides a system comprising a label, product or package as described above (in relation to the second aspect of the present invention) and a machine for reading the label, wherein the ink in the label is arranged and configured to elute through the first layer and form an image on the second side of the first permeable layer that is readable by the machine and which changes as time progresses. The machine is configured to detect the image in a plurality of its changed time-dependent states and associate a parameter with the label that has a value that is dependent upon the state of the image at the time of detection.

The parameter value may be indicative of the age of the label. Alternatively, or additionally, the parameter value may indicate the remaining shelf life of a product to which the label may be associated. Alternatively, or additionally, the parameter value may indicate a price of a product to which the label may be associated. Alternatively, or additionally, the parameter value may indicate that a product to which the label may be associated either should or should not be sold at the time of detection by the machine.

The image may form at least part of a barcode, QR code or alphanumeric string that changes appearance with time.

The system preferably comprises a display or other device and the machine may control the display or other device based on the value of one or more of said parameters.

The present invention also provides a method of indicating the state of a product by associating a label as described above (in relation to the second aspect of the present invention) with said product.

The present invention also provides a method of forming a label as described above in relation to the first or second aspects of the present invention.

According to both the first and second aspects of the present invention, the first permeable layer has different areas of different permeability. The layer may be rendered to have such a property by any of the known means. However, the layer is preferably rendered permeable, and to have said different permeabilities in said different areas, by using the process described in UK patent application number 1102337.1 filed on 9 Feb. 2011. Accordingly, the first permeable layer is preferably used as the substrate described in this document and then subjected to the plasma treatment to create the different areas of different permeabilities.

### BRIEF DESCRIPTION OF THE DRAWINGS

The present invention will now be described, by way of example only, and with reference to the accompanying drawings, in which:

FIG. 1 illustrates a schematic of an embodiment of a label of the present invention;

FIG. 2 illustrates a schematic of an example of spatially resolute features on an embodiment of the present invention;

FIG. 3 illustrates colour data from image analyses of an embodiment of the present invention, based on concentrations of red, green and blue spatially resolute features;

FIG. 4 illustrates images corresponding to FIG. 3 at four different time periods after the image has been prepared;

FIG. 5 illustrates colour data from image analyses of a time dependent label over time for two spatially resolute image features at opposite ends of a label;

FIG. 6 illustrates changes in red and green colouration over time from a time point immediately after UV treatment for two adjacent spatially resolute image features of a label packaged in a reduced oxygen environment;

FIG. 7 illustrates changes in red colouration over time for three adjacent spatially resolute image features packaged in a reduced oxygen environment;

FIG. 8 illustrates changes in red colouration for a number of adjacent spatially resolute image features packaged in a reduced oxygen environment for different time periods up to 83 hours; and

FIG. 9 illustrates a method by which the spatially resolute time dependent image properties may be exploited commercially

### DETAILED DESCRIPTION OF PREFERRED EMBODIMENTS

An embodiment according to the first aspect of the present invention relates to a food label. The label has a first layer that is permeable to oxygen such that oxygen can permeate the layer at different rates in different lateral areas of the layer. The label also has a second layer that is impermeable to oxygen. The label also has an ink arranged between and encapsulated by the two layers. The ink is configured to change colour when it comes into contact with oxygen.

When the label is exposed to an atmosphere, such as air, the oxygen in the atmosphere permeates the first layer of the label until it reaches the ink. The air permeates the first layer at a faster rate in a first area than it does in a second area. As such, the ink in the first area of the label changes colour in a shorter duration than the ink in the second area of the label. Accordingly, the image that is formed by the colour changing ink changes in different areas of the label at different times. The image formed by the change in the ink is therefore able to represent how long the first layer of the label has been exposed to an atmosphere containing oxygen. For example, if the ink has changed colour in only one area of relatively high permeability to oxygen then the first layer has only been exposed to the oxygen for a relatively short period of time. On the other hand, if the ink has changed colour in the area of relatively high permeability to oxygen and also in an area of relatively low permeability to oxygen, then the first layer has been exposed to the oxygen for a relatively long period of time.

In this embodiment the label is able to represent how long it has been exposed to air and hence the age of the label. This may be correlated to the age of the food that the label is attached to and so this information may be useful in order to re-price the food or indicate that it will have deteriorated below a certain quality. As the change in label is visual, the label may change so as to automatically and directly indicate a new price to the human onlooker. Alternatively, the image on the label may be a machine-readable code that changes so as to re-price the food.

It is also contemplated that a gas or vapour other than oxygen may cause the ink to change colour. For example, the label may detect a gas or vapour emitted by the food during decomposition, e.g. a ketone or aldehyde.

It is contemplated that the label may be used with products other than food products.

An embodiment according to the second aspect of the present invention relates to a food label. The label comprises ink and a first layer that is permeable to the ink such that the ink can permeate the layer at different rates in different lateral areas of the layer. The label also has a second layer that is impermeable to the ink and the ink is initially arranged between and encapsulated by the two layers.

In use, the ink permeates the first layer of the label at a faster rate in a first area than it does in a second area. As such, the ink permeates the first area of the label in a shorter duration than the ink permeates the second area of the label. Accordingly, the image that is formed by the ink permeating across the first layer changes with time across the different areas of the label. The image formed by ink permeating across the first layer is therefore able to represent the age of the label. For example, if the ink has permeated across the entire thickness of the first layer in only one area of relatively high permeability then the label has only been formed for relatively short period of time. On the other hand, if the ink has permeated across the entire thickness of the first layer in the area of relatively high permeability and also in an area of relatively low permeability, then the label has been formed for a relatively long period of time.

In this embodiment the label is able to visually change so as to represent the age of the label. This may be correlated to the age of the food that the label is attached to and so this information may be useful in order to re-price the food or indicate that it will have deteriorated below a certain quality. As the change in the label is visual, the label may change so as to automatically and directly indicate a new price to the human onlooker. Alternatively, the image on the label may be a machine-readable code that changes so as to re-price the food.

It is contemplated that the label may be used with products other than food products.

### DETAILED DESCRIPTION OF THE DRAWINGS

Preferred embodiments of the present invention will now be described with reference to the drawings.

FIG. 1 illustrates an environment sensitive label according to a preferred embodiment of the present invention. The label comprises a high barrier substrate that is printed with discrete areas of UV and oxygen sensitive ink. A very thin layer of barrier material having varying barrier properties is the coated or deposited across the substrate so as to produce a time and environment sensitive label. Importantly, this method produces a label where spatially resolute time-dependent change is tailored by varying the through thickness direction permeability of the barrier layer (shown by multiple arrows), where the variation in this property is produced in the direction of the plane of the substrate. By controlling flow perpendicular to the plane/surface of the label in this manner localised colour change effects can be controlled and managed very effectively.

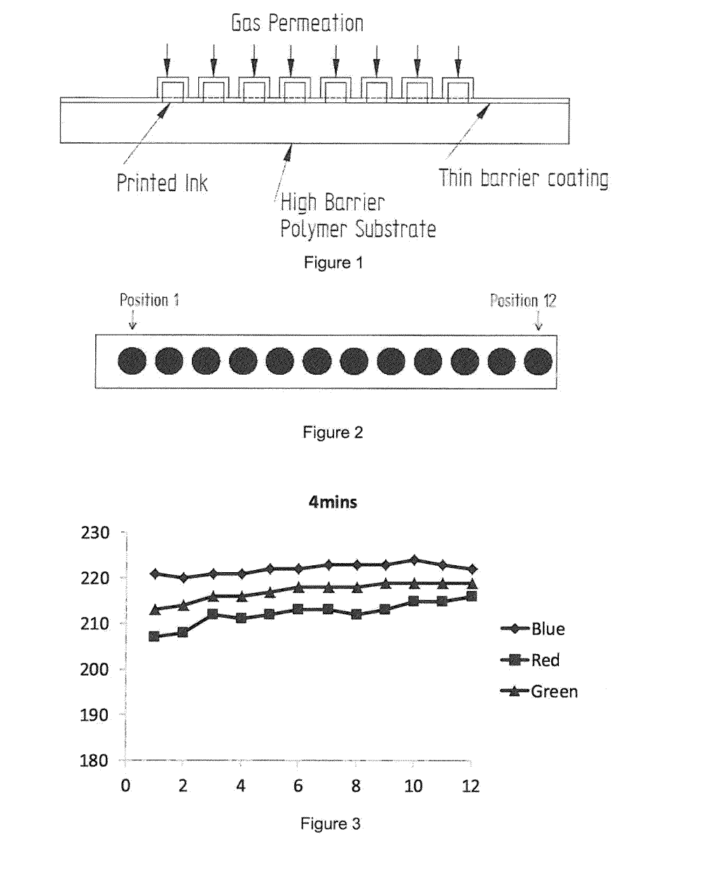

Referring now to FIGS. 2 and 3, there is illustrated the location of the analysis points on a single time-dependent label and data indicating the spatial resolution of colouration from image analysis. The image was produced by printing an oxygen and UV sensitive ink onto the surface of a high barrier polymer substrate. The substrate was treated using methods described in GB 1102337.1 or PCT/GB2012/000130 to achieve variable permeability, followed by consistent UV exposure across the strip. FIG. 3 shows colour data from image analyses four minutes after preparing the label. The ink is seen by the naked eye as a single colour, although the red, green and blue components are analysed by the analyser. It can be seen that there was a trend upwards from left to right showing a variation in the colour of the image components across the different image analysis positions. This demonstrates the capacity to affect colouration in a spatially resolute manner using a barrier that has been created with different permeabilities to oxygen in different areas. The trends are best exhibited by the red and green components. The values shown are the absolute values as measured directly.

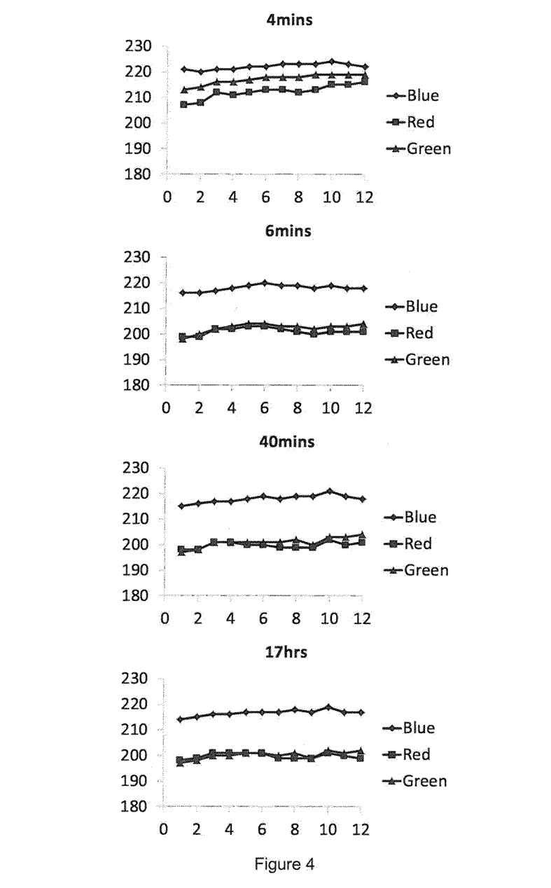

FIG. 4 illustrates a series of four datasets for four different time periods after the image has been prepared. These data sets correspond to that shown in FIG. 3, except that they were taken at 4 minutes, 6 minutes, 40 minutes and 17 hours after preparation of the label. These data sets demonstrate spatially dependent changes in the colour components over time. The gradients of the red and green lines change with respect to time. The decline in the slopes of the lines show change in colour components that occurs over a more prolonged period at position 12 as compared to position 1. As with FIG. 3, these values are shown directly as measured.

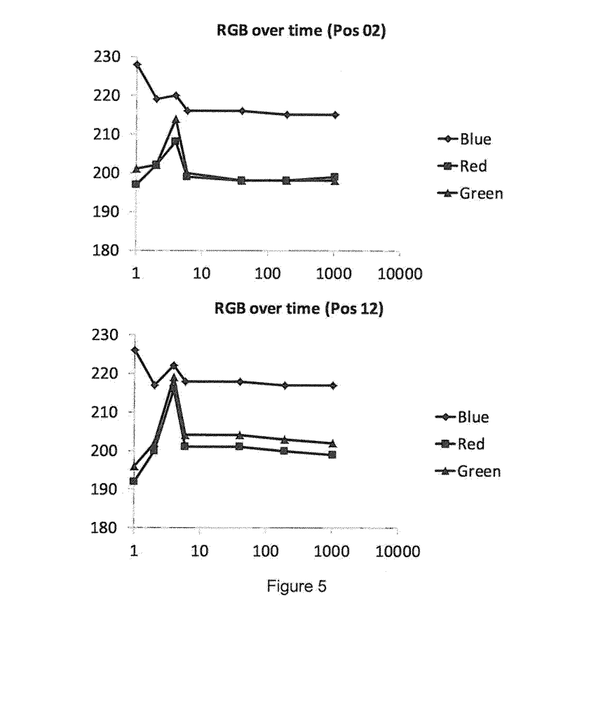

FIG. 5 illustrates colour data from image analyses of a time-dependent label over time for two spatially resolute image features at opposite ends of the label, i.e at image analysis positions corresponding to positions 2 and 12 of FIG. 2. More specifically, FIG. 5 illustrates the time-dependent changes on the same time-dependent image at positions 2 and 12. The x axis is a log scale showing time points up to 1000 minutes.

The first three time points in each graph of FIG. 5 represent measurements made after image printing, after plasma processing to deposit the thin barrier coating of variable permeability), and after UV exposure from a UV light source (that is not the plasma) respectively. As with FIGS. 3 and 4, these values are shown directly as measured. As the ink is oxygen and UV light sensitive, the appearance of the ink is affected by contact with oxygen, e.g. from the air, and from sources of UV light. The plasma process generates UV radiation, the effect of which can be seen by changes in colouration of the colour components of the ink between the first and second time points. The plasma process has different intensities at positions 2 and 12 as the plasma process is used to create a barrier coating having different permeabilities at positions 2 and 12. The different intensities of the plasma process at the different positions results in the ink being exposed to different intensities of UV radiation at the two positions, which can be seen by comparing the two graphs in FIG. 5. It will be appreciated that the ink had a composition such that the blue component did not respond to the UV radiation in the same way as the red and green components

After the plasma processing, a UV light source that is unrelated to the plasma process is used to expose the ink to UV light and enhance the change in the colouration of the colour components. This can be seen by the change between the second and third time points in each of the graphs in FIG. 5. After the third time point in each graph of FIG. 5, the colouration changes due to oxygen permeating through the barrier layer and into contact with the ink. The oxygen interacts with the ink and reduces the colouration for red and green colour components and counteracts the change in colouration of these components that was caused by exposure to UV radiation. The blue component did not respond to the UV radiation in the same way as the red and green components and so the oxygen did not appear to have a counteracting affect in this part of the spectrum.

The rate of change in ink colouration with time is different at position 2 as compared to position 12 because the oxygen permeates through the barrier coating at different rates at these positions. At position 2 the permeability of the barrier is relatively high and so the ink colour relaxation due to oxygen exposure occurs relatively rapidly. The ink approaches its original colouration at the time of printing (for red and green components) in a relatively short time after exposure to UV radiation from the plasma and UV light source because the high permeation rate of oxygen through the deposited barrier layer at position 2. In contrast, at position 12, where the barrier layer is less permeable to oxygen, the relaxation process takes much longer to occur and so the red and green components of the colouration do not reach their values at the time of printing even at 100 minutes.

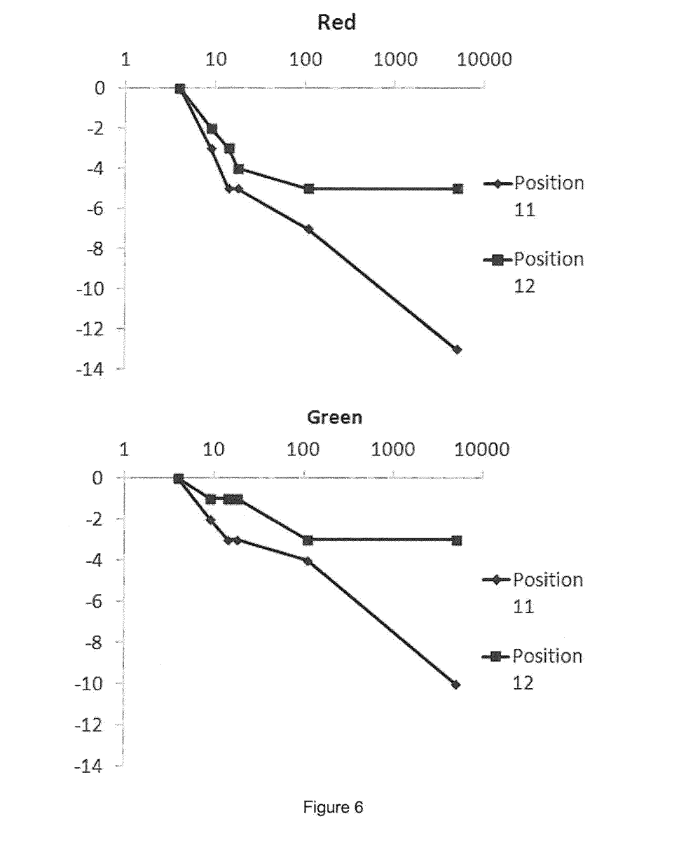

FIG. 6 illustrates data for a sample having the same plasma treatment as the previous sample, but with a longer exposure to the UV light source and packaged in a reduced oxygen environment. The data is presented in terms of change in colouration from a reference point immediately after UV treatment. Following the change in levels of red and green for a period of a number of days, high spatial resolution can be observed between neighbouring points, i.e. positions 11 and 12. The changes at each position indicate different characteristics up to 5000 minutes, where the position with a higher barrier to permeability (position 12) takes longer for the colouration to return to the original value prior to exposure to UV radiation. This can be clearly seen in both red and green.

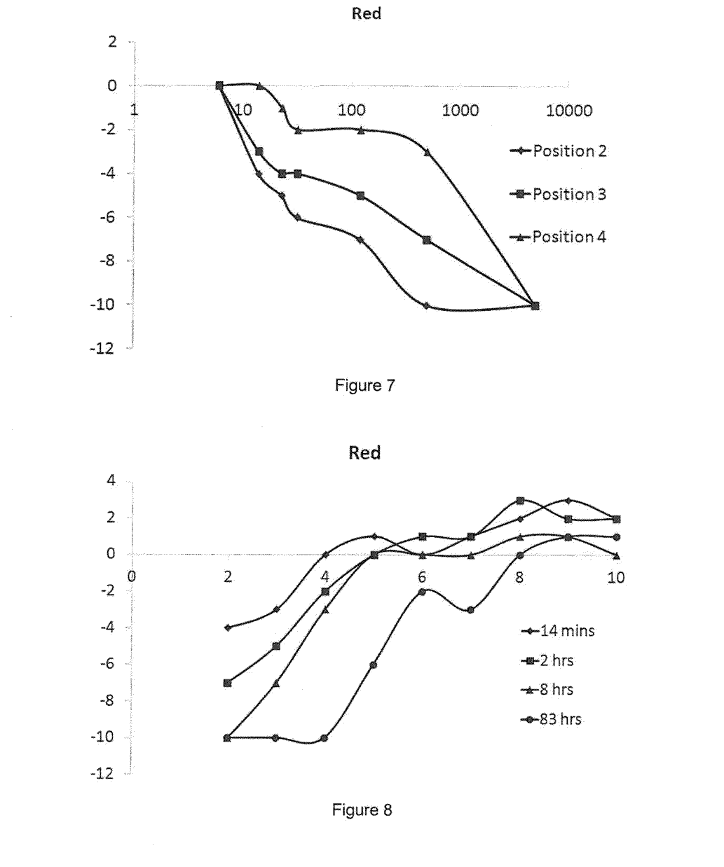

FIG. 7 illustrates further evidence of spatially resolute time-dependent change over a wider range for positions 2 through 4 on a different sample. The sample was subject to lower levels of both plasma and UV treatments than FIG. 5 and packaged in a reduced oxygen environment. Here, the reduction in permeability moving from position 2 to position 4 results in the ink taking longer to approach its original colour, i.e. the colour prior to exposure to UV radiation.

FIG. 8 illustrates the level of red on the same label under the same conditions, but at different times. From left to right there is a general decrease in the permeability of the deposited barrier layer to oxygen. Methods described in GB 1102337.1 or PCT/GB2012/000130 have been used to provide a further localised decrease in permeability in the central region. The overall effect is that the barrier can be seen to slow the process of relaxation of the colour with an enhanced retardation of the process at point 6. In other words, the reduction in colouration with time is reduced at position 6 relative to what it would have been due to the localised decrease in permeability at position 6. The different lines represent different time points. At 8 hours, the most permeable part of the barrier (position 2) has allowed for full relaxation of the ink condition to occur and the other positions are shown to follow the same trend with a time lag or dependence associated with the increased barrier to permeability. This indicates that a reduced oxygen enclosed or packaged environment can extend the relaxation period. In this example it is shown that it is possible to indicate changes over timescales from minutes to four days and possibly even longer on a single image.

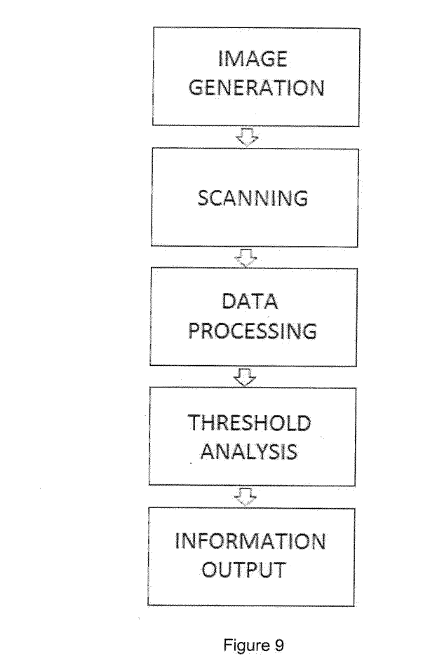

FIG. 9 illustrates the methods by which the permeability through the thickness of the thin variable permeability barrier layer (e.g. FIG. 1) and the resulting controlled spatially resolute time-dependent change in colour (e.g. FIG. 7) may be used to provide environmental and time-dependent feedback in commercial use. The key here is that threshold analysis can be based on a large number of potential measurements or derivations including: absolute values, change in absolute values, gradients of absolute values, change of values, gradients of change of values, whether at specific positions, referenced against other positions on the strip or referenced against previous points in time. Using threshold analysis, image analysis software can be used to provide digital outputs, i.e. yes/no feedback for multiple characteristics from what would be considered an analogue input. The capacity to tailor underlying trends as described here also makes the technology suitable for anti-counterfeiting and encryption.

Although the barrier coating has been described as having a variable permeability to oxygen, it may have a variable permeability to different gases, vapours or gas or vapour components that induce a colour change in the ink.

As described herein above, the present invention includes a layer that has different areas of differing permeability to a gas, vapour or ink. The areas of differing permeability are preferably produced according to PCT/GB2012/000130. The present invention therefore provides a label or a method of producing a label in which the permeable layer (referred to as a substrate below) is modified by using a plasma so as to have differing permeabilities. The method preferably comprises: providing a first electrode and a second electrode; arranging the substrate such that only a portion of the substrate is between the electrodes; rotating either the substrate or at least one of the electrodes about an axis so as to cause different portions of said substrate to pass between the electrodes during said rotation; and supplying a voltage to at least one of the electrodes so as to create a plasma discharge between the electrodes which contacts at least said portions of the substrate that pass between the electrodes; wherein the electrodes and the substrate are arranged such that said rotating causes the speed of transit of the substrate portion between the electrodes to vary in a radial direction away from the axis of rotation; and wherein said electrodes are arranged and said rotation occurs such that an area of the substrate that is further from the axis of rotation passes between the electrodes and is modified by the plasma discharge at lower rate than an area of the substrate that is closer to the axis of rotation and which passes between the electrodes.

The plasma discharge is preferably driven by applying a high voltage to one of the electrodes. The term ‘high voltage’ is intended to mean a voltage sufficient to generate a plasma discharge between the electrodes. It will be appreciated that the plasma may be achieved by supplying said high voltage to at least one of the electrodes. Preferably the plasma discharge process occurs at or close to atmospheric pressure. Preferably, the plasma discharge process is a dielectric barrier discharge process.

Various parameters may be varied with time so as to change the plasma condition between the electrodes. As such, the process may be used to provide different areas on the substrate with different surface modifications or with different degrees of the same modification so as to vary the permeability to a gas, vapour or ink. The system therefore enables the application of inherently different chemical and topological changes in relatively close proximity on the substrate and in rapid succession.

Preferably, a gas is present between the electrodes so that when the high voltage is applied an electrical discharge is provided through the gas between the electrodes to create the plasma. The electrodes and substrate to be treated are arranged such that as the substrate or one of the electrodes rotates only a portion of the substrate passes between the electrodes and so that only a portion of the substrate is exposed to and treated by the plasma at any given time.

Preferably, the first and/or second electrode extends in a direction perpendicular to said axis of rotation so that the plasma generated between the electrodes is in contact with an area of said substrate that extends in a direction perpendicular to the axis of rotation.

At least a portion of the first electrode and at least a portion of the second electrode are preferably substantially parallel to each other and define a gap between the substantially parallel portions. Part of the substrate passes through this gap as the substrate (or one or both of the electrodes) rotates about the axis of rotation. It will be appreciated that the plasma is generated between these parallel portions of the electrodes and treats the surface of the substrate in this gap. The substrate is preferably substantially planar and the plane of the substrate is preferably substantially parallel to the portions of the electrodes between which the substrate is rotated.

Preferably, the substrate is arranged on a platen that is rotated (relative to said second electrode) about said axis so as to cause said rotating of the substrate. The platen preferably comprises a rotatable disc on which the substrate to be treated is mounted. The platen is preferably circular and centred on the axis of rotation. Alternatively, or additionally, the substrate to be treated may be circular.

The rotatable platen preferably comprises the first electrode. As such, the plasma is preferably generated between the substrate (which is mounted on the first electrode) and the second electrode. The first electrode may be a circular electrode centred about the axis of rotation of the platen and therefore also centred on the axis of rotation of the substrate. In one configuration, the first electrode may be covered in an electrical insulator. The electrical insulator may cover at least the surface of the first electrode on which the substrate is placed. Preferably, the first electrode is completely encased in an electrical insulator. If the first electrode can not be made electrically insulating, the second electrode is adjusted so as to create the conditions to create a plasma discharge. For example, the high voltage may be supplied to the second electrode (instead of to the first electrode) in order to create the plasma discharge.

The first and second electrodes are preferably arranged inside a chamber or other form of enclosure and the second electrode remains static relative to the chamber. In a less preferred embodiment the second electrode may be moveable in a direction radially towards and away from the axis of rotation.

Preferably, the second electrode extends along the first electrode (with a portion of the substrate therebetween) and in a direction radially outward from said axis of rotation. The second electrode is therefore preferably an elongated member, such as, for example, a wire electrode, a tubular electrode or a rod electrode. The second electrode preferably extends radially outwards from adjacent to the axis of rotation. The second electrode preferably extends radially outwards to an outer edge of the first electrode. When the first electrode is a circular electrode in the rotating platen, the second electrode preferably extends from the axis of rotation to the outer edge of the first electrode. Less preferably, the second electrode may be arranged in a non-radial direction and/or from a non-central position from the axis of rotation. The plasma is generated between the opposing portions of the first and second electrodes so as to treat the portion of the substrate that is between the electrodes.

Preferably, at least the portion of the second electrode that generates a plasma with the first electrode is a straight electrode. Less preferably, at least this portion of the second electrode may be curved or bent in other ways.

As the first and second electrodes preferably extend radially outwards from the axis of rotation of the substrate, the speed of transit of the substrate through the discharge region between the electrodes varies in a radial direction away from the axis of rotation. When further away from the axis of rotation, the substrate has a higher angular velocity relative to the angular velocity of the substrate when it is closer to said axis. As such, the substrate to be treated passes through the discharge region between the electrodes more quickly the further away from said axis the substrate is. As such, the energy dose delivered to the substrate by the plasma may decrease with increased distance from the axis of rotation. This effect may be used to treat different areas of the substrate by different amounts, such as by treating inner areas of the substrate more heavily than outer areas of the same substrate.

The second electrode may be an elongated member comprising a conduit and apertures along its length. Gas may be delivered through the conduit and the arrangement of said apertures may be located such that the gas exits the electrode and is delivered to the gap between the first and second electrodes at these various points. This gas may be used to generate the plasma when the high voltage is applied to the electrodes and/or to modify the surface of the substrate when the plasma is generated. Alternatively, or additionally, the gas may be used to purge the gap between the electrodes of other gases. The use of gases between the electrodes will be discussed in more detail below.

Less preferably, the second electrode may take the form of a point electrode, such as the tip of a wire (e.g. a ball-tipped wire). In this arrangement, the plasma is generated between the point electrode and the first electrode. The point electrode may then be moved radially with respect to the axis of rotation. This electrode may be used to cause the discharge to occur in specific, discrete areas on the substrate.

Preferably, the second electrode is arranged vertically above the first electrode and preferably such that the axis of rotation of the substrate is vertical.

The high voltage may be applied to the electrodes so as to continuously generate a plasma therebetween. This may expose the entire surface of the substrate that passes between the electrodes to the plasma. Alternatively, the high voltage condition may be applied and deactivated sequentially in a “pulsed” manner such that the plasma generated therefrom contacts only a segment of the rotating substrate. The high voltage applied to the electrodes may be varied with time so as to vary the intensity or power produced in the plasma discharge. The high voltage may be varied continuously with time or as one or more step changes.

The high voltage may be repeatedly applied to the electrodes so as to cause a plurality of discharges that are temporally spaced. The frequency of the application of the high voltage may be varied with time.

The distance between the first and second electrodes may be varied with time whilst the plasma is being generated. A high voltage may be applied continuously so as to generate the plasma or may be repeatedly pulsed so as to repeatedly generate the plasma. The distance between the electrodes may therefore be varied whilst the plasma is being continuously generated or between successive pulses. By varying the gap between the electrodes in such a manner a dynamic plasma treatment environment is provided. At smaller electrode spacing the discharge filaments may be distributed within a smaller area on the substrate. At larger electrode spacing, the filaments act over a larger area which may produce a different surface treatment effect. Additionally, or alternatively to varying the spacing with time, the spacing between the electrodes may be varied as a function of the distance from the axis of rotation. Preferably, the spacing between the electrodes is maintained at a spacing of less than 5 mm in the regions in which the plasma is generated.

A portion of the substrate to be treated may be arranged so as to pass between the first electrode and a third (supplementary) electrode and a high voltage may be applied between the first and third electrodes so as to generate a plasma between these electrodes which treats the substrate. The high voltage supplied to the first and third electrodes may be of different magnitude to that applied to the first and second electrodes. Additionally, or alternatively, if the high voltage is repeatedly applied then it may be applied at a different frequency to the frequency of application to the first and second electrodes.

It will be appreciated that fourth or further electrodes may also be provided. Accordingly, a portion of the substrate to be treated may be arranged to pass between the first electrode and a fourth (and possibly further) electrode and a high voltage may be applied between the first and fourth electrodes so as to generate a plasma between these electrodes which treats the substrate. The high voltage supplied to the first and fourth electrodes may be of different magnitude to that applied to the first and second electrodes and/or may be different to that applied to the first and third electrodes. Additionally, or alternatively, if the high voltage is repeatedly applied then it may be applied at a different frequency to the frequency of application to the first and second electrodes and/or a different frequency to the frequency of application to the first and third electrodes.

Any one or more of the above electrodes may be made from steel, stainless steel, aluminium or any suitable conductor. Any one or more of the above mentioned electrodes may be electrically insulated. Preferably, the first electrode serves as the grounded electrode. Alternatively, bias voltages are used to generate the plasma, e.g. a bias voltage may be applied to the first electrode.

As mentioned above, a gas is preferably present between the electrodes so as to generate the plasma when the potential difference is applied across the electrodes. The gas may be from a single gas supply or may be a mixture of different types of gases from different gas supplies. For example, the gas may consist of only air, it may be a mixture of air and one or more other gases from another gas supply, it may consist of only a gas other than air; or it may consist of a mixture of different gases other than air. One or more of the gases may comprise at least one type of liquid in vapour form and the liquid vapour may be carried to the substrate surface in any of the aforementioned delivery configurations by a carrier gas.

The gas or liquid vapour preferably includes chemicals which treat the substrate when the plasma is generated. For example, the gas or liquid vapour may include functional chemicals (e.g. allylamine) for modifying the substrate surface in a manner that includes chemical functionalities when exposed to the plasma. The gas or liquid vapour may include monomers or oligomers (e.g. polyethylene glycol) suited to deposition and/or grafting and/or polymerisation on the substrate when it is exposed to the plasma. In the subsequent text, reference to gases or gas mixtures includes those that might be provided by inclusion of liquid vapours.

The gas pressure in the region where the plasma is generated is preferably at or about atmospheric pressure, although gases at other pressures are contemplated for use in the present invention.

Preferably, the gas is delivered into the gap between the electrodes. The method preferably provides a means of controlling the flow rate of one or more gases into the space between the electrodes. Preferably, a plurality of different gases from different gas sources are caused to flow into the space at different flow rates so that a gas mixture is present between the electrodes which preferably has different concentrations of said different gases. The flow rates may be controlled so as to provide the desired percentage concentrations of each of the different gases in the gas mixture between the electrodes. This may be done in tandem with the use of specific forms of delivery described above.

A plurality of gas flow controllers operating with different flow rates may be provided for delivering gases into the space between the electrodes. Gas supplies for different types of gases may be connected to each of said gas flow controllers, each gas supply preferably being connected to one of the flow controllers by a suitable valve. The valves may then be selectively opened and dosed so that a single type of gas may be selectively supplied to the gap between the electrodes. Alternatively, the valves may then be selectively opened and dosed so that combinations of two or more different gases may be delivered into the space between the electrodes.

Each of the one or more different types of gases may be supplied to the plurality of the flow controllers operating at different flow rates. As such, the valves may be selectively opened and closed to select the flow controller which supplies any given type of gas to the gap between the electrodes. The flow rate of each type of gas can therefore be controlled.

The valves may be controlled manually using a control unit or automatically via a computer interface via software. In one embodiment four flow controllers are provided for delivering gases at different rates. Gas supplies of four different types of gas are connected to each of four flow controllers. A solenoid valve is provided between each of the four source gas lines and each of the four flow controllers, such that four valves control the input to each of the individual four flow controllers. Each valve may be selectively opened or closed so as to allow any one of the different source gases to be delivered at a predetermined flow rate. This provides the functionality to subsequently combine the flows and produce gas mixtures across a very large concentration range. Alternatively different flows may be delivered to the electrode region via separate channels. The number of flow controllers, source gases and associated valves may be scaled up as necessary.

A gas distributor is preferably provided for supplying gas to the space between the electrodes. When different gases are introduced into the space between the electrodes they may be introduced via different flow paths. A gas distributor may be provided which is configured so as to provide and control flows of different gases into the gap between the electrodes in close proximity to each other. Alternatively, a plurality of different gas flows may be connected to a common input line that provides the gases as a mixture into the space between the electrodes.

The single gas or mixture of gases may be supplied uniformly into the space between the electrodes in which the plasma is generated. This may be achieved, for example, by using a gas distributor having a slot or nozzle for supplying the gas or mixture of gases uniformly into the space between the electrodes.

By varying the flow of gas or gases between the electrodes it is possible to vary the plasma conditions or to otherwise vary the concentrations of one or more gases and therefore to vary the substrate treatment leading to modification. Accordingly, the gas or mixture of gases may be supplied non-uniformly into the space between the electrodes in which the plasma is generated. For example, the gas or mixture of gases may be supplied at a plurality of loci between the electrodes. This may be achieved by supplying the gas or gases through a plurality of apertures. The apertures may be the same size or different sizes.

Additionally, or alternatively, the flow rate of the gas or mixture of gases into the space between the electrodes may vary across the substrate to be treated. As such, a higher flow rate may be provided between the electrodes in one region and a lower flow rate provided between the electrodes in another region. The variation in flow rate across the substrate to be treated may be continuous or gradual, or it may include one or more step changes in the flow rate. The variation in gas flow may be selected in a way so as to provide defined localised changes on the substrate to be treated. The gas or gases may be supplied to the space between the electrodes via a plurality of apertures which are of different sizes so as to provide different flow rates through them with attendant effects on the associated plasma conditions and thereby modification.

In addition, or as an alternative to varying the flow rates of the gas or gases spatially across the substrate, the flow rate of the gas or gas mixtures may be varied with time. Additionally, or alternatively, the direction of the gas flow may be varied during the plasma treatment or between successive plasma treatments so as to provide a variation in plasma conditions.

Preferably, a gas is supplied to the region between the electrodes in order to purge this region of other gases prior to the plasma treatment. This purge gas may be the same or different to the gas or gases that are present when the plasma is generated by applying a potential difference to the electrodes. The purge gas may be supplied so as to cover the entire substrate to be treated or so as to primarily occupy the region between the electrodes. The electrodes and substrate are preferably housed in a chamber or other enclosure and the purge gas may be used to purge the entire chamber of other gases prior to the plasma treatment. Alternatively, the purge gas may be controlled so as to blanket the substrate to be treated in order to provide a barrier between the substrate and other gases. In this configuration the requirement for purging the entire chamber prior to sample treatment may be negated.

As has been described above, the second electrode may provide directly for the gas distribution, wherein the second electrode has vents, apertures or slots so as to allow gas or gases to pass out of the electrode. Alternatively, the gas distributor may be provided as a separate member to the electrodes. This separate member may be slotted or apertured or have vents to allow for the gas flows as described above. It is also contemplated that both the second electrode and one or more separate members may act as combined gas distributors. For example, one of the gas distributors may supply gas for use in purging and another gas distributor may be used for supplying gas for use to modify the substrate during the plasma treatment process.

Both the high voltage applied to the electrodes and/or the gas flow to the gap between the electrodes may be controlled based on feedback mechanisms. These feedback mechanisms may detect electrical characteristics of the discharge between the electrodes, detect spectroscopic properties of the discharge between the electrodes; or may analyse the gases present between the electrodes (e.g. before, during or after the plasma treatment).

As described above, the electrodes and substrate are preferably arranged within a chamber or enclosure. The substrate is preferably rotatably supported by one or more members which may be moved by magnetic fields. A magnetic drive unit may be provided for generating magnetic fields that rotate the support member so as to then rotate the substrate about the axis. The magnetic drive unit is preferably arranged outside of the chamber and the magnetic field passes through the chamber wall(s) and drives rotation of the support member and therefore drives rotation of the substrate. Preferably the support member is the rotatable platen described above. Alternatively, the second electrode may be rotated about said axis and the magnetic drive may move the second electrode.

As described above, a rotating platen which comprises the first electrode is preferably used to rotate the substrate. The system is designed so that the platen accepts a tray that is used to hold the substrate to be treated. The tray is preferably in a form such that the substrate can be clamped or otherwise fixed securely to it. This tray provides for the rapid exchange of substrates and protects the substrate from any adverse interaction with the underlying platen, which may be covered by an electrical insulator. This also renders possible automated substrate exchange between a loading chamber and the plasma treatment chamber or enclosure easier. The use of a cleanable tray or tray with a replaceable base material for each consecutive run also eliminates the effects of contamination created by previous substrate treatment runs. The nature of the tray also enables the substrate to be easily pre-treated or post-treated by processes such as hot-embossing or vacuum forming. The frame of the tray may also act as container sidewalls in subsequent processes requiring liquid coverage of the substrate.

The plasma treatment of the present invention may be used to alter the surface chemistry, topography, or morphology of the substrate surface either directly or by using it in combination with a chemical compound for the purposes of adding additional chemical species the surface via grafting or polymerisation. For example, the treatment may change the chemical composition or the roughness of the uppermost region of the substrate surface or may provide for a chemical compound placed on the surface to be tethered to it. As has been described above, various methods may be used in the process to change the chemistry, topography, or morphology across the substrate surface by varying degrees. Any one or combination of two or more of the following may be used to vary the degree of treatment across the substrate; varying the gas flow between the electrodes spatially and/or temporally; varying the spacing between the electrodes spatially and/or temporally; varying the speed or rotation of the substrate between the electrodes; varying the current and/or potential difference applied to the electrodes; and varying the frequency at which the current and/or potential difference is applied to the electrodes.

The substrate may be loaded with biological or non-biological molecules at specific locations on the substrate which, when subjected to the plasma treatment induces grafting or polymerisation or otherwise augments the surface chemistry, morphology or topography of the substrate.

Preferably, the plasma treatment may increase the roughness of the substrate surface by providing a gas between the electrodes and applying a potential difference to the electrodes capable of providing an ablative treatment to the substrate.

Preferably, chemical functionalities may be grafted to the substrate by providing a gas between the electrodes and applying a potential difference to the electrodes such that the plasma effects grafting of the chemical functionalities to the substrate. A liquid or gel may be provided to coat the surface of the substrate with the chemical compound prior to grafting chemical functionalities to the substrate. Additionally, or alternatively, the substrate may be placed on a holder (e.g. a film) having elements and or the chemical functionalities to be transferred to the substrate, and wherein both the substrate and substrate holder are subjected to the plasma so as to transfer some or all of the chemical moieties to the substrate surface during the process.

The plasma treatment may homogeneously or non-homogeneously deposit monomers and/or oligomers on the substrate surface. Additionally, or alternatively, the plasma treatment may homogeneously or non-homogeneously polymerise monomers and/or oligomers on the substrate surface.

Preferably, the substrate may be treated using the plasma and then moved relative to the axis of rotation so that the substrate is rotated about a different point on the substrate. The plasma may then treat the same portion of the substrate for a second time. This approach may be used to create bands having different levels of treatment.

It will be appreciated that any two or more of the above types of plasma treatment may be performed on the same substrate. The treatments may be performed as subsequent processes or may occur simultaneously. When the processes occur simultaneously the gas or gas mixture between the electrodes is selected so as to allow the multiple processes to occur in a concerted way.

It will be appreciated that the present invention may be used to alter the chemistry, topography, or morphology of the substrate to a specific range of depth below the substrate surface. For example, the substrate may be modified up to a depth of at least 5 nanometres, at least at least 10 nanometres, at least 20 nanometres, at least 40 nanometres, at least 60 nanometres, or at least 120 nanometres. The depth to which the substrate is altered may be different in different regions of the substrate.

Any one or combination of two or more of the following may be varied in order to vary the treatment depth across the substrate; varying the gas flow between the electrodes spatially and/or temporally; varying the spacing between the electrodes spatially and/or temporally; varying the speed or rotation of the substrate between the electrodes; varying the current and/or potential difference applied to the electrodes; and varying the frequency at which the potential difference is applied to the electrodes.

As described herein above, the present invention includes a layer that has different areas of differing permeability to a gas, vapour or ink. The areas of differing permeability are preferably produced according to PCT/GB2012/000130. This process can provide further spatially resolute variance in surface chemical condition as a result of plasma exposure. The present invention therefore provides a label or a method of producing a label in which the ink layer is modified by using a plasma so as to have differing optical properties.

1. A product label comprising:
a first layer that is permeable to at least one type of gas or vapour, wherein the permeable layer has different permeabilities to said gas or vapour in different lateral areas of said label; and
a substance that changes colour, light reflectivity or light transmisivity when in contact with said gas or vapour;
wherein the substance is arranged within said label such that said gas or vapour may permeate across the thickness of the layer at different rates in said different lateral areas so as to cause the substance to change colour, light reflectivity or light transmissivity at different rates in said different areas.

2-8. (canceled)

9. The label of claim 1, wherein the change in the substance provides a modification to an existing image, and wherein the existing image is formed by an ink other than said substance.

10. The label of claim 1, wherein the change in the substance forms a new and discrete image, wherein different discrete images are formed by the substance in said different areas.

11. (canceled)

12. The label of claim 1, wherein the image(s) formed by the substance or pre-existing image form at least a portion of a barcode, QR code or alphanumeric string.

13. A product having a label as claimed in claim 1 attached to it.

14. (canceled)

15. The product of claim 13, wherein the permeable layer is arranged between the product and said substance such that the permeable layer is exposed to a gas or vapour that may be emitted by said product.

16. The product of claim 13, wherein the product is food, or wherein said gas or vapour is a product of decomposition of food.

17. (canceled)

18. A package for a product comprising a label according to claim 1.

19-22. (canceled)

23. The package of claim 18, wherein said gas or vapour is a gas or vapour which is contained within or which may be formed within said package; or wherein the package contains a product and said gas or vapour is one emitted by said product.

24-27. (canceled)

28. A system comprising a label as claimed in 1 claim and a machine for reading the label, wherein the substance in the label is arranged and configured to form an image that is readable by said machine and which changes as time progresses when the label is in contact with said gas or vapour, and wherein the machine is configured to detect the image in a plurality of its changed states and associate a parameter with the label that has a value that is dependent upon the state of the image at the time of detection.

29. The system of claim 28, wherein the parameter value is indicative of the amount of time that the label has been in contact with said gas or vapour; or
wherein the parameter value is indicative of the concentration of said gas or vapour that the label has been in contact with; or
wherein parameter value indicates a change in shelf life or remaining shelf life of a product to which the label may be associated; or
wherein the parameter value indicates a price of a product to which the label may be associated; or
wherein the parameter value indicates that a product to which the label may be associated either should or should not be sold at the time of detection by said machine.

30-34. (canceled)

35. The system of claim 28, wherein the system comprises a display or other device and said machine controls said display or other device based on the value of one or more of said parameters.

36. (canceled)

37. A product label comprising:
ink; and
a first layer that is permeable to said ink, wherein the permeable layer has different permeabilities to said ink in different lateral areas of said label; and
wherein the ink is arranged within said label on a first side of said layer such that said ink may permeate across the thickness of the layer to a second side of the layer at different rates in said different lateral areas so that the ink on the second side of the layer forms a time dependent visible image across said different areas.

38-46. (canceled)

47. The label of claim 37, wherein the ink elutes through the first layer and modifies an existing image, as can be seen from said second side of the permeable layer, and wherein the existing image is formed by an ink other than said ink; or
wherein the ink elutes through the first layer and forms a new and discrete image, as seen from said second side of the permeable layer; or
wherein different discrete images are formed by the ink in said different areas.

48-49. (canceled)

50. The label of claim 37, wherein the image(s) formed by the ink or pre-existing image, as seen from said second side, form at least a portion of a barcode, QR code or alphanumeric string.

51-59. (canceled)

60. A system comprising a label as claimed in claim 37 and a machine for reading the label, wherein the ink in the label is arranged and configured to elute through the first layer and form an image on said second side of the first permeable layer that is readable by said machine and which changes as time progresses, and wherein the machine is configured to detect the image in a plurality of its changed states and associate a parameter with the label that has a value that is dependent upon the state of the image at the time of detection.

61. The system of claim 60, wherein the parameter value is indicative of the age of the label; or
wherein parameter value indicates the remaining shelf life of a product to which the label may be associated; or
wherein the parameter value indicates a price of a product to which the label may be associated; or
wherein the parameter value indicates that a product to which the label may be associated either should or should not be sold at the time of detection by the machine; or
wherein the image forms at least part of a barcode, QR code or alphanumeric string that changes appearance with time.

62-65. (canceled)

66. The system of claim 60, wherein the system comprises a display or other device and said machine controls said display or other device based on the value of one or more of said parameters.

67. (canceled)

68. A method of forming a label as claimed in claim 37.

69. The method of claim 68, wherein said permeable layer having said different permeabilities in different lateral areas is created by exposing a layer to a plasma process having different intensities at said different lateral areas, or
wherein said permeable layer is created by a plasma process depositing said layer, said plasma process having different intensities at different regions so as to deposit said permeable layer with different permeabilities in said different lateral areas.

70-74. (canceled)
